(19) United States
(12) Patent Application Publication
(10) Pub. No.: US 2002/0194293 A1
(43) Pub. Date: Dec. 19, 2002

(54) Communications system and method therefor

(76) Inventor: John H. Osman, Cedar Park, TX (US)

Correspondence Address: Motorola, Inc., Austin Intellectual Property Law Section, MD: TX32/PL02, 7700 West Parmer Lane, Austin, TX, 78729, US

(21) Appl. No.: 09/880,928

(22) Filed: Jun. 13, 2001

(51) Int. Cl. G06F 15/167

(52) U.S. Cl. 709/213

(57) ABSTRACT

A communications system (100) has a client device (102) such as a cell phone that can run application suites such as games. The application suites have a core and a plurality of extensions. The application suites can run with less than all of the extensions. If a user desires an additional extension and its attendant functionality, perhaps during application execution, the user of the client device (102) is informed of the cost of the extension and the storage requirements. The user then can choose to submit a request, via a demodulator/modulator (114), for the extension. A server device (104) responds to the request via a demodulator/modulator by transmitting the extension, updates its records as to the status of the client device, and may submit a bill to the user for transmitting the extension.

### RELATED APPLICATION

This is related to U.S. patent application Ser. No. 09/800,935 filed Mar. 8, 2001, and entitled “Method and Device for Creating and Using Pre-Internalized Program Files” and is incorporated herein by reference and assigned to the current assignee hereof.

### FIELD OF THE INVENTION

The present invention relates generally to communications systems, and more specifically, to wirelessly provisioning applications.

### RELATED ART

After a portable device has been deployed, the user has limited space left within the memory of the portable device for adding new applications or customizing the new or any existing applications. Also, different users of portable devices may desire different applications or features, and service providers may want to keep track of the applications and features currently existing on a portable device. Therefore, a need exists for a communications system that allows applications to be added or extended in view of the limited memory space available. A need also exists for a communications system that allows a service provider to control or monitor such additions and extensions.

### BRIEF DESCRIPTION OF THE DRAWINGS

The present invention is illustrated by way of example and not limitation in the accompanying figures, in which like references indicate similar elements, and in which:

FIG. 1 illustrates, in block diagram form, a communications system according to one embodiment of the present invention.

FIG. 2 illustrates one embodiment of an application and extension storage of FIG. 1.

FIG. 3 illustrates, in block diagram form, another representation of a client device of FIG. 1.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

After portable devices such as wireless phones, pagers, personal data assistants (PDAs), and the like are deployed, the user has limited space left within the memory of the device for adding new applications. Likewise, different users of a same type of portable device may desire different applications and different features. Embodiments of the present invention allow a user to select additional features and functionalities for an application, as desired. Therefore, the user can decide how best to use the available memory of the portable device. Embodiments of the present invention allow a user the ability to customize his or her portable device by selecting and paying for only those extensions he or she desires. Also, embodiments of the present invention allow a service provider to wirelessly provision the desired extensions while being able to monitor the functions and features of each client portable device as well as charge a user for requesting and receiving any desired extensions. The ability to wirelessly provision such extensions (through the use of demodulation/modulation interfaces on both the client and server devices) allows for convenient portability for the user. It also give the user the ultimate choice on which functions and features to obtain.

One aspect of the present invention relates to a communications system having application storage means for storing an application suite that has a core and an extension, an execution means, coupled to the application storage means, for running the application suite and sending a request for the extension in the course of running the core if the extension is not present in the application storage means; and a first demodulation/modulation interface, coupled to the execution means, for transmitting the request.

Another aspect of the present inventions relates to a communications system having a client device for running an application suite having a core and an extension, detecting if the extension is present, requesting a user to initiate a request for the extensions, and generating a wireless request for the extension in response to the user initiating the request. In this embodiment, the communications system also includes a server device, coupled to the client device by a communications channel, for providing the extension to the client device in response to the request and generating a bill for providing the extension to the client.

Yet another aspect of the present invention relates to a communications system having application storage means for storing a plurality of application suites, wherein each application suite has a core and a plurality of extensions, execution means, coupled to the application storage means, for running a selected application suite from the plurality of application suites and sending a request for a first extension from the plurality of extensions of the selected application suite in the course of running the core of the selected application suite if the first extension is not present in the application means, and a demodulation/modulation interface, coupled to the execution means, for transmitting the request.

Another aspect of the present invention relates to a method for communicating including providing storage means for storing an application suite having a core and an extension, and in the course of running the core, determining if the storage means contains the extension. The method further includes providing a demodulator/modulator means for transmitting and receiving information and transmitting a request for the extension via the demodulator/modulator means if the storage means does not contain the extension.

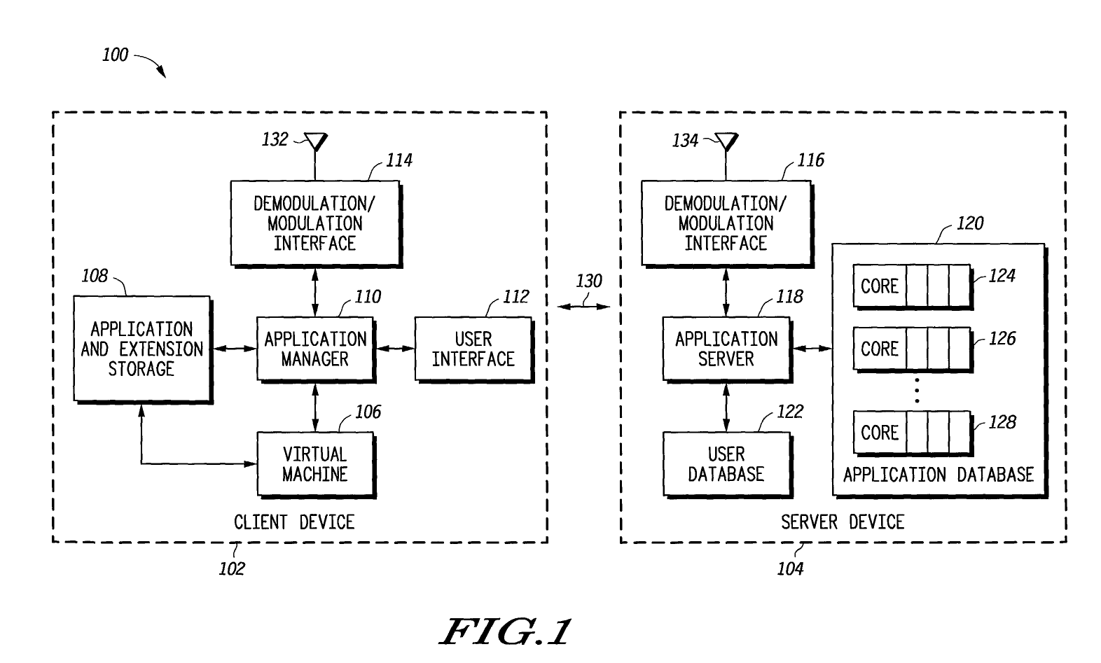

FIG. 1 illustrates, in block diagram form, a communications system 100 in accordance with one embodiment of the present invention. Communications system 100 includes client device 102 and server device 104. Client device 102 communicates with server device 104 via a communication channel 130. In one embodiment, communication channel 130 is a wireless communication channel; however, in alternate embodiments channel 130 may be a wireline or any other appropriate networking connection. Therefore, antennas 132 and 134 receive and transmit information via channel 130. Client device 102 includes antenna 132 coupled to demodulation/modulation interface 114. Client device 102 also includes application manager 110 bidirectionally coupled to demodulation/modulation interface 114, application and extension storage 108, user interface 112, and virtual machine (VM) 106. Application and extension storage 108 is also bidirectionally coupled to virtual machine 106. In one embodiment, client device 102 is a portable device capable of running an interpretive language such as the Java® language (Java is a trademark of Sun Microsystems), where virtual machine 106 is a Java® VM which includes, for example, a Java® interpreter and class loader. In alternate embodiments, client device 102 is capable of running other interpretive languages, or of running any other high level programming languages which may or may not be interpretive languages. Therefore, although client device 102 includes a virtual machine such as VM 106 that runs on a processor, in alternate embodiments, VM 106 may be any execution means such as the processor itself. Also, in one embodiment, client device 102 is a wireless portable device such as a wireless or cellular phone, pager, PDA (personal digital assistant), or the like.

Server device 104 includes antenna 134 coupled to demodulation/modulation interface 116. Server device 104 also includes application server 118 bidirectionally coupled to demodulation/modulation interface 116, user database 122, and application database 120. Application database 120 includes application suites 124, 126, and 128. Each application suite may include one or more applications, and application database 120 may include more or less application suites than the three illustrated in FIG. 1. Each application suite includes a core and zero or more application extensions. The core provides a predetermined set of functionalities of the corresponding application suite. Each application extension provides additional functionalities which further expand the corresponding application suite. In one embodiment, server device 104 is a carrier such as a network carrier, an internet service provider, or the like.

In operation, demodulation/modulation interface 114 receives and transmits information via antenna 132. Demodulation/modulation interface 114 receives signals via channel 130 and demodulates them prior to providing the signals to application manager 110. Similarly demodulation/modulation interface 114 modulates signals from application manager 110 prior to transmitting them with antenna 132 via channel 130. The same applies to demodulation/modulation interface 116 where signals are demodulated prior to reaching application server 118 and are modulated prior to application server 118 sending them to a client device via antenna 134 and channel 130. Therefore, demodulation/modulation interfaces 114 and 116 allow communication which utilizes a carrier signal such as, for example, RF (radio frequency) communication. This allows for increased portability since client device 102 may therefore be any wireless device, such as a cellular phone or pager or the like.

Application manager 110 presents to the user via user interface 112 available application suites resident on the client device. These application suites include those that are readily available for execution by VM 106 without having to load them from a server device (such as server device 104). User interface 112 may communicate with an input device (such as a keyboard, mouse, touch screen, number pad, or the like) and an output device (such as a display or the like) in order to communicate with the user of client device 102. Application manager 110 invokes VM 106 to run the selected application suite from application and extension storage 108.

As in some systems available today, application manager 110 may also present to the user (via user interface 112) a list of application suites which are not currently resident on client device 102, but are resident instead on server device 104. In this embodiment, application manager 110 requests, via demodulation/modulation interface 114, the selected application suite from server device 104. Server device 104 then provides the full selected application suite from application database 120 via demodulation/modulation interface 116 and communication channel 130 to client device 102. However, as in the systems available today, if a user wants only to extend certain features or functions of an existing application, the user must reobtain the full new extended version of the application suite from server device 104. This can be time consuming, depending on the size of the application suite. Furthermore, the user does not have the option to simply obtain the needed or desired extensions of an application and likewise, cannot customize the application without reobtaining and reloading the full application suite. Therefore, as will be discussed below, embodiments of the present invention allow users to customize their application suites and obtain extensions for their application suites as needed or as desired without having to reobtain and reload the full application suite each time.

As discussed above, application suites may include one or more applications. For example, an application suite may include a set of 2 games, where each game can be considered an application. Furthermore, each of the two games may include a variety of different playing levels. This 2-game application suite can then be partitioned into a core portion and a set of extensions, where, for example, the core portion includes each of the two games and a predetermined set of playing levels, while any additional levels can be considered extensions of the core. This is only one example of how to partition the application suite since it may be partitioned in a variety of different ways which still result in a core and extensions. Generally, the core is capable of running without the use of its extensions (or with less than all of its extensions), and each additional extension can run with the core without the existence of the other extensions. (However, in alternate embodiments, depending upon the partitioning chosen, some extensions may be dependent upon other extensions or the core, meaning that they may not function independently.) Therefore, any application suite can be partitioned into a core and extensions of the core, where the extensions add more functionalities, features, and the like to the core.

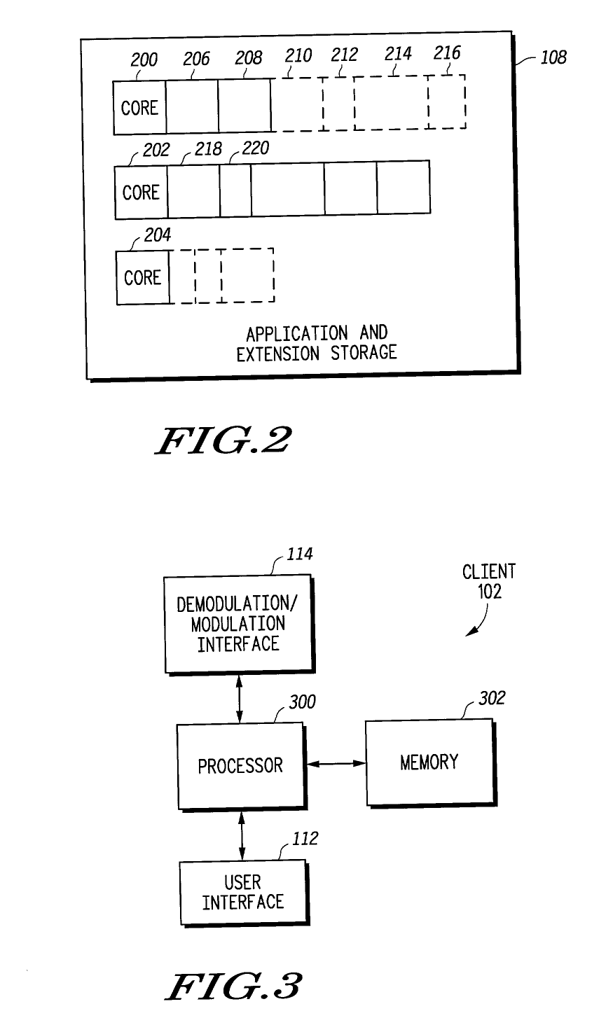

The ability to partition application suites allows a user to select which set of application suite extensions, if any, should be included on client device 102. Therefore, the user is able to customize each application by selecting the desired extensions. For example, FIG. 2 illustrates a portion of application and extension storage 108 of client device 102. Application and extension storage 108 includes application suite cores 200, 202, and 204. In this embodiment, application and extension storage 108 also includes extensions 206 and 208 corresponding to core 200, extensions 218 and 220 corresponding to core 202, and no extensions corresponding to core 204. The dotted lines in FIG. 2 indicate the extensions that may be available for each core. These extensions would reside in server device 104. For example, extensions 210, 212, 214, and 216 are available for core 200, but are not resident on client device 102. However, all the available extensions for core 202 are available on client device 102, as illustrated by the lack of dotted lines. Also, each extension may be a different size, some requiring more storage space than others. Therefore, it can be understood how a user can select different extensions for each core. This can save space within application and extension storage 108 by not having to store unused extensions or extensions deemed unnecessary (and thus not chosen) by the user.

As the user runs a selected application on client device 102, the user may be presented with available extensions (via user interface 112) that are not already resident on client device 102. This allows for the dynamic growth of an application suite. That is, as the application runs, the user may decide to add one or more of the available extensions. The full application suite need not be reloaded onto client device 102 because the core is already resident on client device 102. Thus, the user, at runtime, can add functionality to the current application through an extension to the existing (and running) core. The user can therefore update or expand the application fairly seamlessly, without substantially interrupting the current execution of the application.

In an alternate embodiment, application manager 110 may present to the user any application suites and extensions available from server device 104. In this embodiment, the user does not need to be running an application in order to select any additional extensions. Therefore, this allows for the growth of existing application suites through the use of extensions, but not dynamic (i.e. runtime) growth as in the previous embodiment. Also in this embodiment, the user may choose to retrieve other application suite cores and their desired extensions as well as additional extensions for cores already existing on client device 102. In alternate embodiments, client device 102 may provide both options to the user. That is, while running an application, the user may be presented with available extensions (for dynamic growth) and while not running an application, the user can select an available extension for one of its existing applications. The user may also have the option to select more than one extension during any given request.

When the user requests a new extension, the execution means (e.g. VM 106) requests the selected extension from application manager 110. Application manager 110, via demodulation/modulation interface 114, sends an initial request for the selected extension to server device 104. In one embodiment, prior to sending the initial request to server device 104, application manager 110 determines whether client device 102 has sufficient available memory for storing the requested extension. The user can then be informed if sufficient storage exists via user interface 112. In alternate embodiments, as will be discussed below, server device 104 may determine the sufficiency of available memory on client device 102 by using user database 122.

Upon the user choosing to add an extension, application manager 110 sends an initial request to server device 104 for the selected extension. The initial request also serves to identify client device 102 (i.e. the source of the request) to server device 104 so that server device 104 can be aware of which client device sent the request. Upon receiving the initial request for the selected extension, server device 104 may verify that client device 102 is capable of receiving the requested extension. For example, client device 102 may not have sufficient available memory for storing the extension, client device 102 may not have the required core for the extension, or other problems (such as, for example, screen size, driver availability, and the like) may prevent client device 102 from being able to receive and run the selected extension. Server device 104 has access to the current status of each client device, such as client device 102, within user database 122. For example, user database 122 includes information about client device 102 such as its available memory space, screen size, existing applications, service plans, and the like. User database 122 may therefore include more or less information about each client device, depending on the requirements or design of server device 104. If the initial request is determined to be valid, server device 104 determines the billing information regarding the requested extension. For example, some extensions may only be available for a predetermined dollar amount while others may be free of charge. Server device 104 then transmits whether the request is valid and any billing information associated with the request to client device 102 to allow the user to determine whether to accept the billing charges and storage requirements and receive the requested extension.

Application manager 110 therefore alerts the user (via user interface 112) to the cost and storage requirements associated with the requested extension. The user then has the option of proceeding with the transaction. If the user decides to proceed, a second request is sent to server device 104 to transmit the selected extension. Server device 104, in response to the second request, transmits the selected extension via channel 130 to client device 102. Upon completion of the transmission, server device 104 updates the new status of client device 102 within user database 122 based on the transmission of the requested application extension. For example, the billing information may be recorded for the transaction, the available memory may be updated, and the list of installed applications may also be updated for client device 102. In alternate embodiments, server device 104 may wait for an acknowledge signal from client device 102 to indicate that the transmission of the extension was successful prior to updating user database 122. If unsuccessful, server device 104 can attempt to retransmit the extension. In alternate embodiments, user database 122 may also be updated upon each initial request (whether confirmed or not) sent by client device 102. Therefore, user database 122 may record any type of information, such as any information that may be useful to a user of server device 104. Also note that in alternate embodiments, some of the information stored within user database 122 may also be stored on client device 102. For example, application manager 110 on client device 102 may also present the user with the price for each available extension from server device 104 where the prices may be stored in application and extension storage 108 or any other appropriate memory location within client device 102.

Note that the communication protocol discussed above between client device 102 and server device 104 may be simpler or more complex than that described above. For example, more handshaking signals may be exchanged, or more or less information may be transmitted upon each exchange. Also, more error checking signals and information may be utilized to communicate between the client and server devices.

In one embodiment, the initial request for the selected extension may contain information indicating the nature of the requested extension. For example, an extension may be requested for permanent installation or for transient or temporary use. Permanent installation refers to storing the requested extension into permanent memory such as read only memory (ROM), Flash, EEPROM, or the like, meaning the extension remains on client device 102 upon power down. Alternatively, transient use refers to temporarily storing the requested extension in random access memory (RAM), or the like, on the client device 102, meaning the extension is lost upon power down. In the case of permanent installation, a higher price may be charged than for transient use.

FIG. 3 illustrates, in block diagram form, another representation of client device 102. FIG. 3 illustrates a processor 300 bidirectionally coupled to demodulation/modulation interface 114, user interface 112, and a memory 302. Processor 300 and memory 302 work together to provide a structure and functionality of application and extension storage 108, application manager 110, and virtual machine 106. That is, application manager 110 and virtual machine 106 may be software instructions stored in memory 302 that are fetched and executed by processor 300. Similarly, application and extension storage 108 may also reside in memory 302. Note that memory 302 may include both permanent memory storage (e.g. ROM, Flash, EPROM, EEPROM, etc.) and temporary memory storage (e.g. RAM, etc.). Also, application and extension storage 108, application manager 110, and virtual machine 106, demodulation/modulation interface 114, and user interface 112 may perform more functions than those described above in reference to FIG. 1.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A communications system, comprising:
application storage means for storing an application suite that has a core and an extension;
execution means, coupled to the application storage means, for running the application suite and sending a request for the extension in the course of running the core if the extension is not present in the application storage means; and
a first demodulation/modulation interface, coupled to the execution means, for transmitting the request.

2. The communications system of claim 1, further comprising:
an application database for storing the application suite with the core and the extension; and
a second demodulation/modulation interface, coupled to the application database, for receiving the request for the extension and transmitting the extension.

3. The communications system of claim 2 wherein the application storage means, the execution means, and the first demodulation/modulation interface comprise a client device having a status with regard to the application suite.

4. The communications system of claim 3 further comprising:
a user database for storing the status and updating the status of the client device.

5. The communications system of claim 4, wherein the client device further comprises an application manager coupled between the execution means and the first demodulation/modulation interface.

6. The communications system of claim 5, further comprising an application server coupled between the application database and the second demodulation/modulation interface.

7. The communications system of claim 6, wherein the application server is further characterized as being coupled between the user database and the second demodulation/modulation interface.

8. The communications system of claim 1, further comprising a user interface, coupled to the execution means, for asking a user if the request should be transmitted.

9. A communications system comprising:
a client device for running an application suite having a core and an extension, detecting if the extension is present, requesting a user to initiate a request for the extension, and generating a wireless request for the extension in response to the user initiating the request; and
a server device, coupled to the client device by a communications channel, for providing the extension to the client device in response to the request and generating a bill for providing the extension to the client device.

10. The communications system of claim 9, wherein the client device comprises:
applications storage means for storing the application suite;
execution means, coupled to the applications storage means, for running the application suite; and
a demodulation/modulation interface coupled to the execution means.

11. The communications system of claim 10, wherein the client device further comprises an applications manager coupled between the execution means and the demodulation/modulation interface.

12. The communications system of claim 1, further comprising a user interface, coupled to the applications manager, for informing a user if the applications storage means has sufficient storage capacity for the extension.

13. The communications system of claim 10, wherein the client device comprises a user interface, coupled to the execution means, for asking the user if the request should be transmitted to the server device.

14. The communications system of claim 13, wherein the user interface is further characterized as providing cost information concerning the extension.

15. The communications system of claim 9, wherein the server device comprises:
an application database for storing the application suite with the core and the extension; and
a demodulation/modulation interface, coupled to the application database, for receiving the request and transmitting the extension.

16. The communications system of claim 15 wherein the client device has a status with regard to the application suite and the server device further comprises:
an application server coupled between the application database and the demodulation/modulation interface; and
a user database, coupled to the application server, for storing the status of the client device.

17. A communications system comprising:
application storage means for storing a plurality of application suites, wherein each application suite has a core and a plurality of extensions;
execution means, coupled to the application storage means, for running a selected application suite from the plurality of application suites and sending a request for a first extension from the plurality of extensions of the selected application suite in the course of running the core of the selected application suite if the first extension is not present in the application storage means; and
a demodulation/modulation interface, coupled to the execution means, for transmitting the request.

18. The communications system of claim 17 further comprising a server device, coupled to the demodulation/modulation interface, for transmitting the first extension to the demodulation/modulation interface in response to the request and generating a bill for transmitting the first extension.

19. The communications system of claim 17, further comprising an application manager coupled between the execution means and the demodulation/modulation interface.

20. The communications system of claim 19 further comprising user interface means for displaying a cost for the first extension.

21. A method for communicating, comprising:
providing storage means for storing an application suite having a core and an extension;
in the course of running the core, determining if the storage means contains the extension;
providing a demodulator/modulator means for transmitting and receiving information; and
transmitting a request for the extension via the demodulator/modulator means if the storage means does not contain the extension.

22. The method of claim 21, further comprising:
receiving the request;
transmitting the extension to the demodulator/modulator means; and
sending a bill for transmitting the extension.

23. The method of claim 22, further comprising:
identifying a source of the request for the extension; and
updating a status of the source for transmitting the extension.
